(19) United States
(12) Patent Application Publication
(10) Pub. No.: US 2006/0230220 A1
(43) Pub. Date: Oct. 12, 2006

(54) Fibre channel switch system, information processing system, and login procedure

(76) Inventors: Yoshiko Yasuda, Tokorozawa (JP); Masaji Kume, Ebina (JP); Tomonaga Itoi, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/397,750

(22) Filed: Apr. 5, 2006

(30) Foreign Application Priority Data
Apr. 6, 2005 (JP) 2005-109536

(51) Int. Cl. G06F 13/00

(52) U.S. Cl. 710/316

(57) ABSTRACT

Provided is a fibre channel switch system to which a server and a storage system are connected. The fibre channel switch system includes: a host controller for controlling a fibre channel protocol, to which the server is connected; a management table for indicating a hardware address of the host controller; a switching unit for routing information of the fibre channel protocol; and a control unit for controlling the host controller and the switching unit. Accordingly, the server connected to fibre channel switch system can be downsized.

### CLAIM OF PRIORITY

The present application claims priority from Japanese patent application P2005-109536 filed on Apr. 6, 2005, the content of which is hereby incorporated by reference into this application.

### BACKGROUND OF THE INVENTION

This invention relates to a fibre channel switch for routing information, and more particularly, to a fibre channel switch connected to a plurality of servers.

A blade server system with a built-in fibre channel switch (FC switch) has recently gained in popularity. The blade server is a high-density system by mounting a plurality of server blades in one chassis. A server blade is one thin and long blade-shaped circuit board that is equipped with hardware and software for server functions. The server blade accesses a storage system for storing various pieces of information through the embedded FC switch.

Generally in the blade server system with the embedded FC switch, each server blade has one or more host bus adapters' (HBA) (e.g., refer to U.S. Pat. No. 6,771,499).

Each HBA records a world wide name (WWN) in a flash memory or a ROM. The WWN is a 64-bit address used in fibre channel networks to uniquely identify each element in a Fibre Channel network. The FC switch manages a correspondence between the WWN and a port ID.

Now, processing of the FC switch of this conventional technology will be described.

First, when the server blade accesses the FC switch at the first time, the FC switch assigns a usable port. The FC switch records a correspondence between a WWN of the server blade which has accessed the FC switch and an assigned port ID of the assigned port. Then, the FC switch notifies the assigned port ID to the server blade.

The server blade uses the notified port number for access to the FC switch thereafter. When the server blade sends the FC request with the port number to the FC switch, the FC switch refers to the correspondence between the WWN and the port ID to interconnect the server blade and the storage system.

There is known a technology of mounting a TCP/IP processor (TOE) and a network interface card (NIC) to a LAN switch incorporated in the blade server (e.g., refer to JP 2004-355351 A).

There is additionally known a storage area network (SAN) management system which has an integration management mechanism for integrally managing the FC switch and the HBA (e.g., refer to JP 2002-63063 A)

### SUMMARY OF THE INVENTION

However, the conventional blade server system with the embedded FC switch has problems as follows. The server blade mounted in the conventional blade server system includes the HBA mounted therein, so it is difficult to miniaturize server blades. Moreover, the conventional blade server system needs the same number of HBA's as that of server blades.

In the conventional blade server system, the HBA and the WWN correspond to each other on a one to one basis. Accordingly, the conventional blade sever system has a problem of complex processing when an error occurs in the mounted server blade.

For example, according to a first method of dealing with failuers, the WWN of the down server blade is overwritten with that of an alternative server blade. Then, after recovery from the failure, the WWN of the alternative server blade must be returned to the original.

According to another method of dealing with failures, the HBA of the down server blade is taken out, and the HBA is mounted in an alternative server blade.

As a result, the conventional blade server system has a problem since the management cost increases because of complex processing when a failure occurs.

This invention provides an FC switch system which can solve the problems.

According to an embodiment of this invention, there is provided a fibre channel switch system to which a server and a storage system are connected, characterized by including: a host controller for controlling a fibre channel protocol, to which the server is connected; a management table for holding a hardware address of the host controller; a switching unit for routing information of the fibre channel protocol; and a control unit for controlling the host controller and the switching unit. The host controller converts information received from the server into the information of the fibre channel protocol.

According to the fibre channel switch system of this invention, the server blade to be connected can be miniaturized. Furthermore, the information processing system can reduce management costs by being equipped with the fibre channel switch system of this invention.

### BRIEF DESCRIPTION OF THE DRAWINGS

The present invention can be appreciated by the description which follows in conjunction with the following figures, wherein:

FIG. 1 is a block diagram of an information processing system according to a first embodiment of this invention;

FIG. 2 is a diagram showing a structure of a hardware address management table according to the first embodiment of this invention;

FIG. 3 is a block diagram showing a hardware address management unit according to the first embodiment of this invention;

FIG. 4 is a block diagram showing a host controller according to the first embodiment of this invention;

FIG. 5 is a flowchart showing log-in processing of the host controller according to the first embodiment of this invention;

FIG. 6 is a block diagram showing an information processing system according to a second embodiment of this invention;

FIG. 7 is a diagram showing a structure of a hardware address management table according to the second embodiment of this invention;

FIG. 8 is a block diagram showing a hardware management unit according to the second embodiment of this invention; and

FIG. 9 is a diagram showing a configuration of a host controller according to the second embodiment of this invention.

### DETAILED DESCRIPTION OF THE PREFERRED EMBODIMENTS

Referring to the drawings, preferred embodiments of this invention will be described below.

### First Embodiment

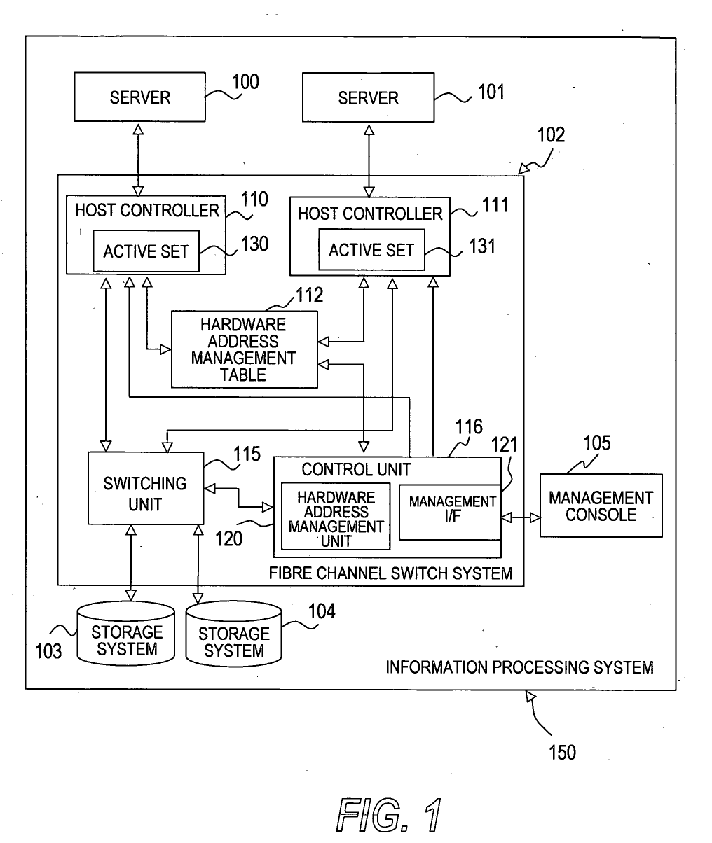

FIG. 1 is a block diagram showing an information processing system 150 according to a first embodiment of this invention.

The information processing system 150 includes servers 100 and 101, a fibre channel switch system 102, storage systems 103 and 104, and a management console 105.

The fibre channel switch system 102 is connected to the server 100 and 101, the storage systems 103 and 104, and the management console 105.

The fibre channel switch system 102 and the servers 100 may be interconnected by any protocol. The fibre channel switch system 102 and the servers 101 may be interconnected by any protocol. Thus, this embodiment will be described by way of case where the fibre channel switch system 102 is connected to the servers 100 and 101 through a PCI bus.

The servers 100 and 101 read/write information in the storage systems 103 and 104 through the fibre channel switch system 102. The two servers 100 and 101 are shown, but any number of servers may be installed. However, the number of servers 100 and 101 must be smaller than that of host controllers 110 and 111 disposed in the fibre channel switch system 102.

For example, the storage systems 103 and 104 are RAID systems and store various information. The two storage systems 103 and 104 are shown, but any number of storage systems may be installed.

The management console 105 is a personal computer equipped with a CPU, a memory, and the like. An administrator inputs setting information for the fibre channel switch system 102 through the management console 105.

The fibre channel switch system 102 connects the servers 100 and 101 to the storage systems 103 and 104 to transfer information. The fibre channel switch system 102 includes host controllers 110 and 111, a hardware address management table 112, a switching unit 115, and a control unit 116.

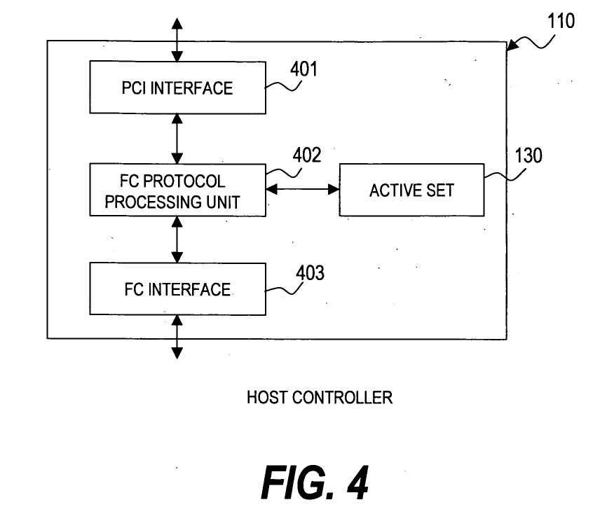

The host controllers 110 and 111 shown in FIG. 4 connect the servers 100 and 101 to the switching unit 115. For example, the host controllers 110 and 111 are HBA's. The two host controllers 110 and 111 are shown, but any number thereof may be installed. Each one of the servers 100 and 101 may be connected to a plurality of host controllers 110 and 111. However, each one of the host controllers 110, and 111 is permitted only to be connected to one server 100 or 101.

Each of the host controllers 110 and 111 is configured to include a plurality of ports (e.g., host controller with multiple ports), and each port may be connected to the switching unit 115. In the case of the host controller with multiple ports, a WWN is assigned to each port.

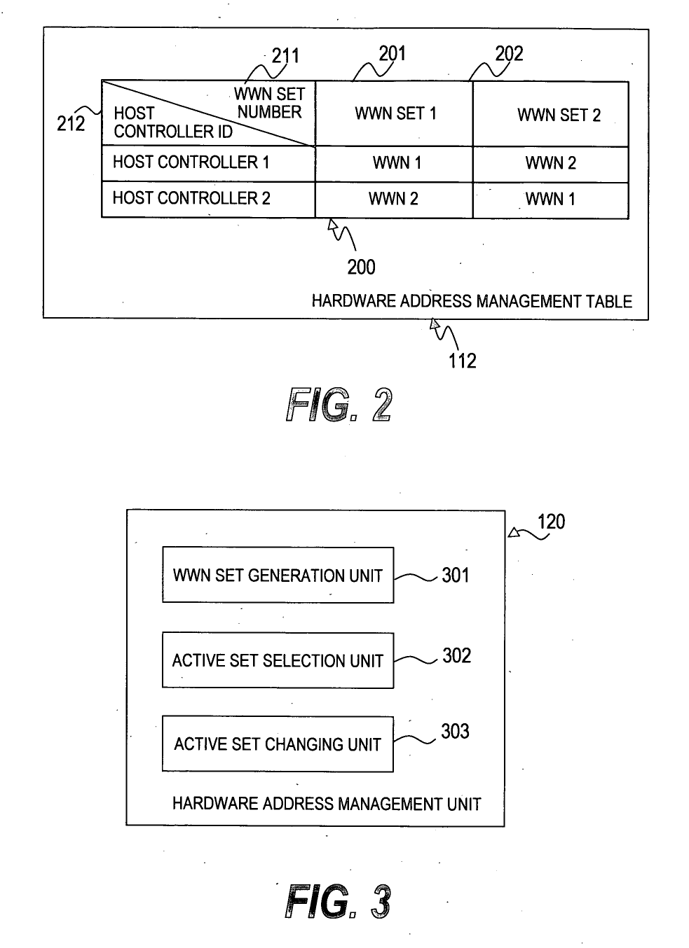

The host controller 110 records an active set 130. Similarly, the host controller 111 records an active set 131. The active sets 130 and 131 are WWN set numbers currently set in the host controllers 110 and 111. The WWN set numbers shown in FIG. 2 will be described in detail.

The switching unit 115 is connected to the host controllers 110 and 111 and the storage systems 103 and 104. As in the case of the conventional FC switch, the switching unit 115 routes information of a fibre channel protocol. Specifically, the switching unit 115 receives a frame of the fibre channel protocol from the host controllers 110 and 111 or the storage systems 103 and 104. Next, the switching unit 115 specifies a destination port based on the received frame, and transfers the frame to the destination port.

One switching unit 115 is shown, but more than one switching units 115 may be installed to deal with failures.

The hardware address management table 112 shown in FIG. 2 indicates correspondences between the host controllers 110 and 111 and WWNs.

The control unit 116 controls the whole fibre channel switch system 102. The control unit 116 includes a hardware address management unit 120 and a management interface (management I/F) 121.

The hardware address management unit 120 shown in FIG. 3 manages the host controller 110 and 111 and the hardware address management table 112.

The management interface 121 is connected to the management console 105. The management interface 121 may include its own Application Program Interface (API) or a standard API to manage the fibre channel switch system 102. When the management interface 121 includes the standard API, the management console 105 accesses the management interface 121 by using a standard communication protocol to manage the fibre channel switch system 102.

As described above, the fibre channel switch system 102 includes the host controllers 110 and 111. Accordingly, the servers 100 and 101 do not need to include their own host controllers 110 and 111 when they are connected to the fibre channel switch system 102. Hence, it is possible to miniaturize the servers 100 and 101.

FIG. 2 is a diagram showing a structure of the hardware address management table 112 according to the first embodiment of this invention.

The hardware address management table 112 contains a WWN set management table 200.

The WWN set management table 200 contains a WWN set number 211 and a host controller ID 212.

The WWN set management table 200 may be physically located in one place or physically dispersed. For example, each of the host controllers 110 and 111 may be configured to include a part of the WWN set management table 200.

The WWN set number 211 is a unique identifier of the WWN set. The WWN set is a combination of WWN's assigned to the host controllers 110 and 111. The host controller ID 211 is a unique identifier of each of the host controllers 110 and 111.

In other words, the WWN set management table 200 shows a WWN assigned to each of the host controllers 110 and 111 where the WWN sets have been set.

For example, when the WWN set number 211 is set to “WWN SET 1”, a WWN of “HOST CONTROLLER 1” is “WWN 1”, and a WWN of “HOST CONTROLLER 2” is “WWN 2” (record 201).

Also, when the WWN set number 211 is set to “WWN SET 2”, a WWN of “HOST CONTROLLER 1” is “WWN 2”, and a WWN of “HOST CONTROLLER 2” is “WWN 1” (record 202).

In the case of the host controllers with multiple ports 110 and 111, a host controller ID is provided for each port of the host controllers 110 and 111. For example, a case where “HOST CONTROLLER 1”, includes two ports of “PORT A” and “PORT B” will be described. In this case, “HOST CONTROLLER 1-A” is assigned as a host controller ID to “PORT A” of “HOST CONTROLLER 1”, and “HOST CONTROLLER 1-B” is assigned as a host controller ID to “PORT B” of “HOST CONTROLLER 1”. Then, a WWN assigned to each port is shown in the WWN set management table 200. For example, the WWN set management table 200 stores “WWN 1A” for “HOST CONTROLLER 1-A”, and “WWN 1B” for “HOST CONTROLLER 1-B”.

The fibre channel switch system 102 of the embodiment includes the hardware address management table 112. Thus, the fibre channel switch system 102 can properly change WWN's assigned to the host controllers 110 and 111.

FIG. 3 is a block diagram showing the hardware address management unit 120 according to the first embodiment of this invention.

The hardware address management unit 120 includes a WWN set generation unit 301, an active set selection unit 302, and an active set changing unit 303.

The WWN set generation unit 301 generates the WWN set management table 200.

Specifically, the WWN set generation unit 301 creates a plurality of WWN sets. Then, the WWN set generation unit 301 stores the created WWN sets in the WWN set management table 200.

The active set selection unit 302 sets WWN sets in the host controllers 110 and 111.

Specifically, when the servers 100 and 101 first access the fibre channel switch system 102, the active set selection unit 302 selects WWN set numbers. The active set selection unit 302 transmits the selected WWN set numbers to the host controllers 110 and 111. Then, the host controllers 110 and 111 store the received WWN set numbers as active sets 130 and 131.

For example, the active set selection unit 302 selects a WWN set number set to an initial value.

Additionally, the active set selection unit 302 may select a WWN set number corresponding to one of the servers 100 and 101 which has first accessed the active set selection unit 302. For example, the active set selection unit 302 selects “WWN SET 1”, when first accessed from the server 100. On the other hand, the active set selection unit 302 selects “WWN SET 2” when first accessed from the server 101.

The active set selection unit 302 may receive a WWN set number to be selected from the management console 105. In this case, the active set selection unit 302 causes the management console 105 to display the hardware address management table 112. The administrator selects the WWN set number 211 of the hardware address management table 112 displayed by the management console 105. Then, the active set selection unit 302 sets the selected WWN set number 211 in the host controller.

The active set changing unit 303 changes the WWN set numbers set in the host controllers 110 and 111.

For example, when a predetermined time is reached, the active set changing unit 303 changes the WWN set numbers. Accordingly, the active set changing unit 303 can change the storage systems 103 and 104 used by the servers 100 and 101 according to a time.

The active set changing unit 303 changes the WWN set numbers according to the failure detection of the servers 100 and 101.

As an example, a case where a failure occurs in the server 100, and an alternative of the server 100 is a server 101 will be described. In this case, the active set changing unit 303 changes a WWN set number to assign a WWN assigned to the host controller 110 connected to the server 100 to the host controller 111 connected to the server 101.

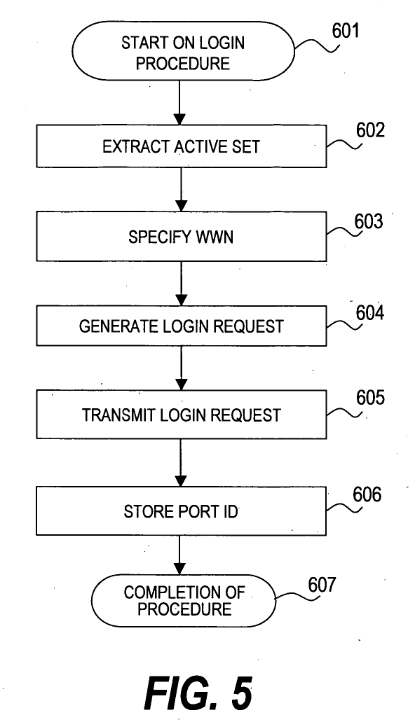

When there is stored a port ID corresponding to the WWN assigned to the host controller 110, the host controller 110 or the server 100 deletes the stored port ID. Then, the host controller 110 performs login procedure shown in FIG. 5 by using a new WWN calculated from the changed WWN set number. Accordingly, the host controller 110 can obtain a port ID corresponding to the new WWN.

As another method, the host controller 110 may store a correspondence between the WWN set number and a port ID obtained by using the WWN set number. In this case, the host controller 110 stores a table showing a correspondence between the WWN set number and the port ID. By this method, at the time of changing the active set, the host controller 110 searches in the table by using a WWN set number corresponding to the changed active set to obtain a port ID corresponding to the WWN set number. Then, the host controller 110 sets the obtained port ID therein again.

In other words, any method can be used as long as the host controller 110 can correctly obtain a port ID corresponding to a newly assigned WWN.

In other words, the active set changing unit 303 can switch the damaged server 100 to the alternative server 101 only by changing the WWN set number. Thus, the fibre channel switch system 102 of the embodiment can quickly and easily deal with the failuers of the servers 100 and 101 by being equipped with the active set changing unit 303.

FIG. 4 is a block diagram showing the host controller 110 according to the first embodiment of this invention.

The host controller 110 includes a PCI interface 401, an FC protocol processing unit 402, an FC interface 403, and an active set 130.

The PCI interface 401 is connected to the server 100 through a Peripheral Components Interconnect (PCI) bus. The PCI interface 401 may be connected through PCI-X or PCI Express in place of the PCI bus. The host controller 110 may be connected to the server 100 through its own interface in place of the PCI interface 401. Any own interface may be used as long as the interface allows mapping of a request from the server in the FC protocol.

The FC protocol processing unit 402 controls the fibre channel protocol. Specifically, the FC protocol processing unit 402 converts information received from the PCI interface 401 into a fibre channel protocol. The FC protocol processing unit 402 executes log-in processing shown in FIG. 5 when first accessed from the servers 100 and 101.

The FC interface 403 is connected to the switching unit 115 through a fibre channel.

The active set 130 is a WWN set number currently set in the host controller 110.

The host controller 111 is identical in configuration to the host controller 110.

Thus, the fibre channel switch system 102 of the embodiment is connected to the servers 100 and 101 through the PCI bus.

FIG. 5 is a flowchart showing a login procedure of the host controller 110 according to the first embodiment of this invention.

Upon first access from the server 100, the host controller 110 starts login procedure (601).

First, the active set 130 stored therein is extracted (602).

Then, a WWN set therein is specified based on the extracted active set 130 and the hardware address management table 112 (603).

Specifically, a block where the extracted active set 130 coincides with the WWN set number 211 of the WWN set management table 200 and ID of the host controller 110 coincides with the host controller ID 212 of the WWN set management table 200 is selected from the WWN set management table 200. Then, a value stored in the selected block is specified as a WWN set therein.

Then, a login request containing the specified WWN is generated (604).

Subsequently, the generated login request is transmitted to the switching unit 115 (605).

The switching unit 115 receives the login request. Then, the switching unit 115 extracts a WWN from the received login request. The switching unit 115 assigns a port ID to the extracted WWN. The switching unit 115 transmits the assigned port ID to the host controller 110.

The host controller 110 stores the received port ID (606).

The host controller 110 uses the stored port ID in access to the switching unit 115 thereafter.

Then, the host controller 110 completes the login processing (607).

Similarly, the host controller 11 executes login processing upon first access from the server 101.

### Second Embodiment

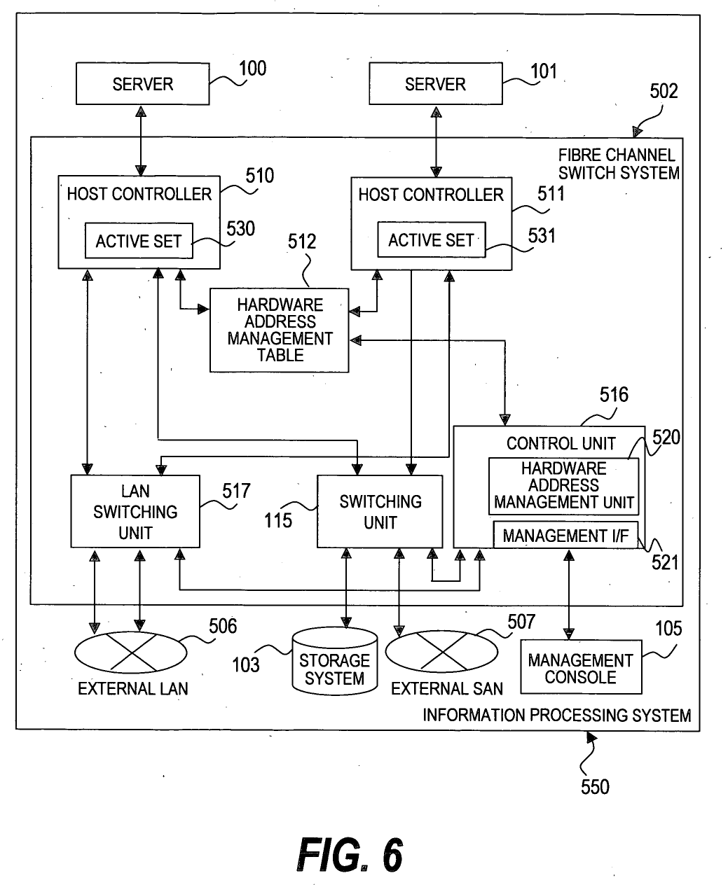

FIG. 6 is a block diagram showing an information processing system 550 according to a second embodiment of this invention.

The information processing system 505 includes servers 100 and 101, a fibre channel switch system 502, the storage system 103, the management console 105, an external LAN 506, and an external SAN 507.

The servers 100 and 101, the storage system 103, and the management console 105 are identical to those of the information processing system 150 shown in FIG. 1 of the first embodiment. Similar components will be denoted by similar reference numerals, and description thereof will be omitted.

The external LAN 506 is a Local Area Network (LAN) located outside the fibre channel switch system 502. The external SAN 507 is a Storage Area Network (SAN) located outside the fibre channel switch system 502.

The fibre channel switch system 502 includes host controllers 510 and 511, a hardware address management table 512, a switching unit 115, a control unit 516, and a LAN switching unit 517.

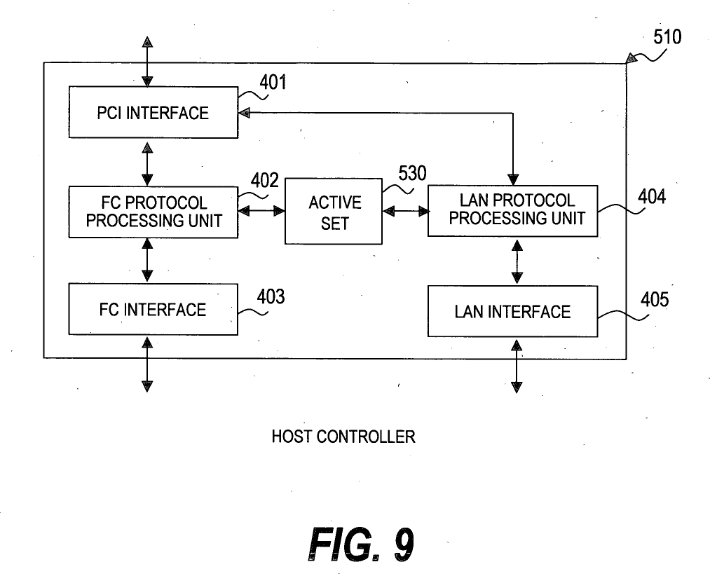

The host controllers 510 and 511 connect the servers 100 and 101 to the switching unit 115, and to the LAN switching unit 517. The host-controllers 510 and 511 shown in FIG. 9 will be described in detail.

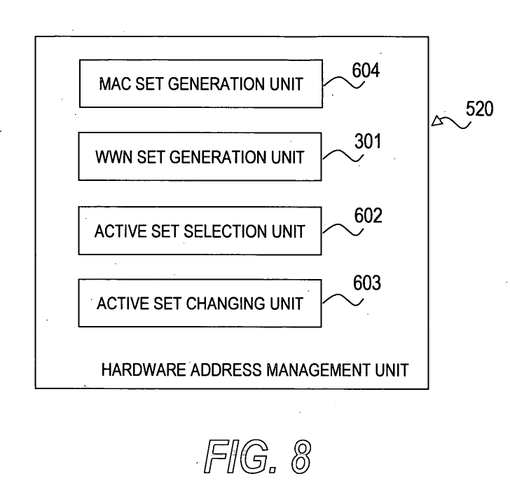

The host controller 510 stores an active set 530. Similarly, the host controller 511 stores an active set 531. The active sets 530 and 531 are a WWN set number and a MAC set number currently set in the host controllers 510 and 511. The MAC set number shown in FIG. 8 will be described below in detail.

The host controller 510 may include a plurality of ports. In this case, a WWN is assigned corresponding to each port.

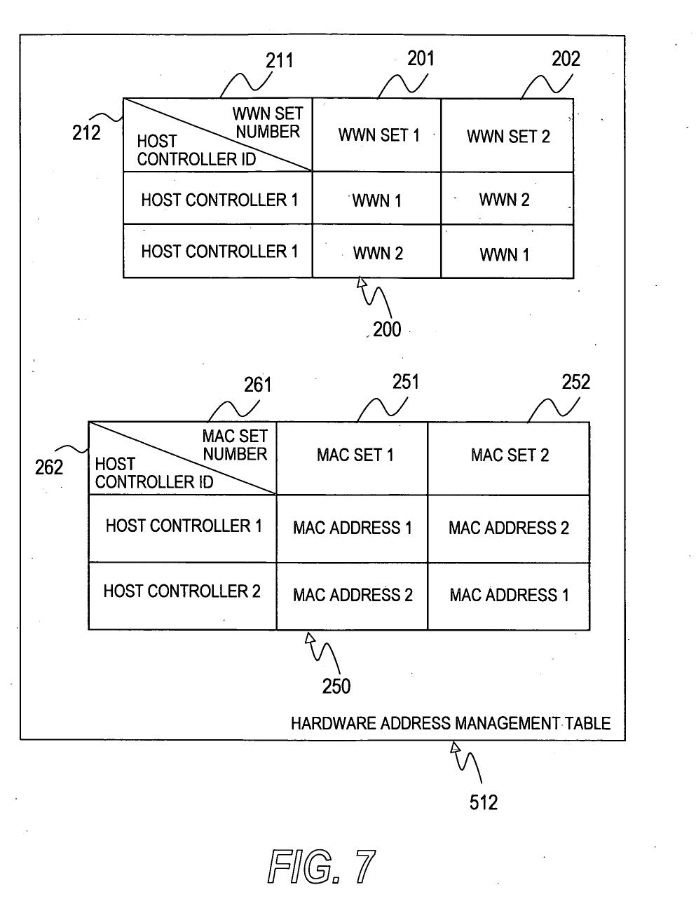

The hardware address management table 512 shown in FIG. 7 shows correspondences between the host controllers 510 and 511 and the WWN and between the host controllers 510 and 511 and the MAC address.

The control unit 516 controls the entire fibre channel switch system 502. The control unit 516 includes a hardware address management unit 520 and a management interface 521.

The hardware address management unit 520 shown in FIG. 8 manages the host controllers 510 and 511 and the hardware address management table 512. The management interface 521 is connected to a management console 105.

The switching unit 115 is identical in configuration to the fibre channel switch system 102 of the first embodiment, and thus description thereof will be omitted.

The LAN switching unit 517 is connected to the host controllers 510 and 511 and the external LAN 506. The LAN switching unit 517 routes information of a LAN protocol. Specifically, the information of the LAN protocol is received from the host controllers 510 and 511 or the external LAN 506. Then, the LAN switching unit 517 judges a transfer destination based on the received information, and transmits the information to the judged transfer destination.

The fibre channel switch system 502 of the embodiment can be connected to the external LAN 506 by being equipped with the LAN switching unit 517. The fibre channel switch system 502 may include a plurality of LAN switching units 517.

FIG. 7 is a diagram showing a structure of the hardware address management table 512 according to the second embodiment of this invention.

The hardware address management table 512 contains a WWN set management table 200, and the MAC set management table 250.

The WWN set management table 200 is identical in structure to the hardware address management table 112 of the first embodiment shown in FIG. 2. Similar components will be denoted by similar reference numerals, and description thereof will be omitted.

The MAC set management table 250 contains a MAC set number 261 and a host controller ID 262.

The MAC set number 261 is an identifier unique to the MAC set. The MAC set is a combination of MAC addresses assigned to the host controllers 510 and 511. The host controller ID 262 is a unique identifier of each of the host controllers 510 and 511.

In other words, the MAC set management table 250 shows a MAC address assigned to each of the host controllers 510 and 511 where the MAC sets have been set.

For example, when the MAC set number 261 is set to “MAC SET 1”, a MAC address of “HOST CONTROLLER 1” is “MAC ADDRESS 1”, and a MAC address of “HOST CONTROLLER 2” is “MAC ADDRESS 2” (record 251).

Also, when the MAC set number 261 is set to “MAC SET 2”, a MAC address of “HOST CONTROLLER 1” is “MAC ADDRESS 1”, and a MAC address of “HOST CONTROLLER 2” is “MAC ADDRESS 1” (record 252).

The fibre channel switch system 502 of the embodiment includes such a hardware address management table 512. Thus, the fibre channel switch system 502 can properly change the WWN and the MAC address assigned to the host controllers 510 and 511. In the case of the host controller with multiports where each one of the host controllers 510 and 511 includes a plurality of ports, a host controller ID is assigned for each port.

FIG. 8 is a block diagram showing the hardware address management unit 520 according to the second embodiment of this invention.

The hardware address management unit 520 includes a WWN set generation unit 301, an active set selection unit 602, an active set changing unit 603, and a MAC set generation unit 604.

The WWN set generation unit 301 is identical in structure to the hardware address management unit 120 of the first embodiment shown in FIG. 3. Similar components will be denoted by similar reference numerals, and description thereof will be omitted.

The MAC set generation unit 602 generates the MAC set management table 250.

Specifically, the MAC set generation unit 602 creates a plurality of MAC sets. Then, the MAC set generation unit 602 stores the created MAC sets in the MAC set management table 250.

The active set selection unit 602 sets WWN sets and MAC sets in the host controllers 510 and 511.

Specifically, when the servers 100 and 101 first access the fibre channel switch system 502, the active set selection unit 602 selects WWN set numbers and MAC set numbers. The active set selection unit 602 transmits the selected WWN set numbers and MAC set numbers to the host controllers 510 and 511. Then, the host controllers 510 and 511 store the received WWN set numbers and MAC set numbers as active sets 530 and 531.

The active set changing unit 603 changes the WWN set numbers and/or the MAC set numbers set in the host controllers 510 and 511.

FIG. 9 is a diagram showing a configuration of the host controller 510 according to the second embodiment of this invention.

The host controller 51.0 includes a PCI interface 401, an FC protocol processing unit 402, an FC interface 403, a LAN protocol processing unit 404, a LAN interface 405, and the active set 530. When it includes a plurality of ports (host controller with multiple ports), the host controller 510 includes pluralities of FC interfaces 403 and LAN interfaces 405.

The PCI interface 401, the FC protocol processing unit 402, and the FC interface 403 are identical in configuration to those of the host controller 110 of the first embodiment shown in FIG. 4. Similar components will be denoted by similar reference numerals, and description thereof will be omitted.

The LAN protocol processing unit 404 controls the LAN protocol. Specifically, the LAN protocol processing unit 404 converts information received from the PCI interface 401 into a LAN protocol.

The LAN interface 405 is connected to the LAN switching unit 517.

The active set 530 contains a WWN set number and a MAC set number currently set in the host controller 510.

The host controller 511 is identical in configuration to the host controller 510.

As described above, the fibre channel switch system 502 of the embodiment is connected to the servers 100 and 101 through the PCI bus. Accordingly, the fibre channel switch system 502 can deal with a plurality of protocols including TCP/IP, a fibre channel, iSCSI and the like.

Each of the host controllers 510 and 511 can receive information of the LAN protocol from the server 100 by being equipped with the LAN protocol processing unit 404 and the LAN interface 405. Hence, the fibre channel switch system 502 can connect the servers 100 and 101 to the external LAN 506.

This invention is suitably applied to an integrated service platform. The integrated service platform is a system where a server, a fibre channel switch system, a storage system, and the like are stored in one case.

This invention can be used for the blade server contributing to miniaturization of the server blade stored in the blade server.

While the present invention has been described in detail and pictorially in the accompanying drawings, the present invention is not limited to such detail but covers various obvious modifications and equivalent arrangements, which fall within the purview of the appended claims.

What is claimed is:

1. A fibre channel switch system connected to a server and a storage system, comprising:
a host controller connected to the server for controlling a fibre channel protocol;
a management table for indicating a hardware address of the host controller;
a switching unit for routing information of the fibre channel protocol; and
a control unit for controlling the host controller and the switching unit.

2. The fibre channel switch system according to claim 1, wherein the management table includes a correspondence between the host controller and the hardware address.

3. The fibre channel switch system according to claim 1, wherein the management table includes plural correspondences between the host controller and the hardware address.

4. The fibre channel switch system according to claim 1, wherein the hardware address comprises a world wide name.

5. The fibre channel switch system according to claim 1, wherein the control unit comprises a table management unit for managing the management table.

6. The fibre channel switch system according to claim 5, wherein:
the management table includes plural correspondences between the host controller and the hardware address; and
the table management unit comprises:
a table creation unit for creating the management table;
an active set selection unit for selecting one of the correspondences included in the management table and setting the selected correspondence in the host controller; and
an active set changing unit for changing the correspondence set in the host controller.

7. The fibre channel switch system according to claim 1, wherein the control unit comprises a management interface connected to a management console to which information is input.

8. The fibre channel switch system according to claim 1, wherein:
the host controller controls a network protocol; and
the management table includes a correspondence between the host controller and a hardware address of a network.

9. The fibre channel switch system according to claim 8, wherein the hardware address of the network comprises a MAC address.

10. The fibre channel switch system according to claim 9, further comprising a LAN switch for routing information of the network protocol.

11. The fibre channel switch system according to claim 1, wherein the host controller is connected to the server through a PCI interface.

12. The fibre channel switch system according to claim 1, further comprising a nonvolatile memory for storing various pieces of information,
wherein the nonvolatile memory stores the management table.

13. An information processing system, comprising:
a server;
a storage system; and
a fibre channel switch system connected to the server and the storage system,
wherein the fibre channel switch system comprises:
a host controller connected to the server for controlling a fibre channel protocol;
a management table for indicating a hardware address of the host controller;
a switching unit for routing information of the fibre channel protocol; and
a control unit for controlling the host controller and the switching unit.

14. A login procedure for a fibre channel switch system connected to a server and a storage system,
the fibre channel switch system comprising:
a host controller connected to the server for controlling a fibre channel protocol;
a management table for indicating a hardware address of the host controller; and
a switching unit for routing information of the fibre channel protocol,
the login procedure comprising the steps of:
setting an active set indicating a correspondence between the host controller and the hardware address in the host controller;
specifying the set active set;
extracting hardware address of the host controller from the management table based on the specified active set;
creating a fibre channel log-in request containing the extracted hardware address; and
transmitting the created fibre channel log-in request to the control unit.
